(19) United States
(12) Patent Application Publication
(10) Pub. No.: US 2007/0117042 A1
(43) Pub. Date: May 24, 2007

(54) Imaging methods

(75) Inventors: Robert K. Barr, Shrewsbury, MA (US); Corey O'Connor, Worcester, MA (US)

Correspondence Address: John J. Piskorski;Rohm and Haas Electronic Material LLC, 455 Forest Street, Marlborough, MA, 01752, US

(73) Assignee: Rohm and Haas Electronic Materials LLC, Marlborough, MA (US)

(21) Appl. No.: 11/287,102

(22) Filed: Nov. 23, 2005

(51) Int. Cl. G03C 1/00

(52) U.S. Cl. 430/270.1

(57) ABSTRACT

Methods of imaging are disclosed. Imaging compositions which are sensitive to low levels of energy are applied to a work piece. Energy is applied to the imaging compositions to cause a color or shade change such that workers may modify the work piece based on the color or shade change.

The present invention is directed to imaging methods. More specifically, the present invention is directed to imaging methods using imaging compositions which undergo color or shade changes upon exposure to low energies.

There are numerous compositions and methods employed in various industries to form images on substrates to mark the substrates. Such industries include the paper industry, packaging industry, paint industry, medical industry, dental industry, electronics industry, textile industry, aeronautical, marine and automotive industries, and the visual arts, to name a few. Imaging or marking typically is used to identify an article such as the name or logo of a manufacturer, a serial number or lot number, tissue types, or may be used for alignment purposes in the manufacture of semiconductor wafers, aeronautical ships, marine vessels and terrestrial vehicles.

Marking also is employed in proofing products, photoresists, soldermasks, printing plates and other photopolymer products. For example, U.S. Pat. No. 5,744,280 discloses photoimageable compositions allegedly capable of forming monochrome and multichrome images, which have contrast image properties. The photoimageable compositions include photooxidants, photosensitizers, photodeactivation compounds and deuterated leuco compounds. The leuco compounds are aminotriarylmethine compounds or related compounds in which the methane (central) carbon atom is deuterated to the extant of at least 60% with deuterium incorporation in place of the corresponding hydrido aminotriaryl-methine. The patent alleges that the deuterated leuco compounds provide for an increased contrast imaging as opposed to corresponding hydrido leuco compounds. Upon exposure of the photoimageable compositions to actinic radiation a phototropic response is elicited.

Marking of information on labels, placing logos on textiles, or stamping information such as company name, a part or serial number or other information such as a lot number or die location on semiconductor devices may be affected by direct printing. The printing may be carried out by pad printing or screen printing. Pad printing has an advantage in printing on a curved surface because of the elasticity of the pad but is disadvantageous in making a fine pattern with precision. Screen printing also meets with difficulty in obtaining a fine pattern with precision due to the limited mesh size of the screen. Besides the poor precision, since printing involves making a plate for every desired pattern or requires time for setting printing conditions, these methods are by no means suitable for uses demanding real time processing.

Hence, marking by printing has recently been replaced by ink jet marking. Although ink jet marking satisfies the demand for speed and real time processing, which are not possessed by many conventional printing systems, the ink to be used, which is jetted from nozzles under pressure, is strictly specified. Unless the specification is strictly met, the ink sometimes causes obstruction of nozzles, resulting in an increase of reject rate.

In order to overcome the problem, laser marking has lately been attracting attention as a high-speed and efficient marking method and is already put to practical use in some industries. Many laser marking techniques involve irradiating only necessary areas of substrates with laser light to denature or remove the irradiated area or irradiating a coated substrate with laser light to remove the irradiated coating layer thereby making a contrast between the irradiated area (marked area) and the non-irradiated area (background).

Using a laser to mark an article such as a semiconductor chip is a fast and economical means of marking. There are, however, certain disadvantages associated with state-of-the art laser marking techniques that burn the surface to achieve a desired mark. For example, a mark burned in a surface by a laser may only be visible at select angles of incidence to a light source. Further, oils or other contaminants deposited on the article surface subsequent to marking may blur or even obscure the laser mark. Additionally, because the laser actually burns the surface of the work piece, for bare die marking, the associated burning may damage any underlying structures or internal circuitry or by increasing internal die temperature beyond acceptable limits. Moreover, where the manufactured part is not produced of a laser reactive material, a laser reactive coating applied to the surface of a component adds expense and may take hours to cure.

Alternatively, laser projectors may be used to project images onto surfaces. They are used to assist in the positioning of work pieces on work surfaces. Some systems have been designed to project three-dimensional images onto contoured surfaces rather than flat surfaces. The projected images are used as patterns for manufacturing products and to scan an image of the desired location of a ply on previously placed plies. Examples of such uses are in the manufacturing of leather products, roof trusses, and airplane fuselages. Laser projectors are also used for locating templates or paint masks during the painting of aircraft.

The use of scanned laser images to provide an indication of where to place or align work piece parts, for drilling holes, for forming an outline for painting a logo or picture, or aligning segments of a marine vessel for gluing requires extreme accuracy in calibrating the position of the laser projector relative to the work surface. Typically six reference points are required for sufficient accuracy to align work piece parts. Reflectors or sensors are positioned in an approximate area where the ply is to be placed. Since the points are at fixed locations relative to the work and the laser, the laser also knows where it is relative to the work. Typically, workers hand mark the place where the laser beam image contacts the work piece with a marker or masking tape to define the laser image. Such methods are tedious, and the workers' hands may block the laser image disrupting the alignment beam to the work piece. Accordingly, misalignment may occur.

Another problem associated with laser marking is the potential for opthalmological damage to the workers. Many lasers used in marking may cause retinal damage to workers. Generally, lasers, which generate energy exceeding 5 mW, present hazards to workers.

Accordingly, there is a need for improved imaging methods of marking a work piece.

Methods include providing a composition including one or more sensitizers and one or more photoreducing agents; applying the composition to a work piece; exposing the composition to energy at powers of 5 mW or less to affect a color or shade change and to form an image on the composition; and executing one or more tasks on the work piece based on the image. Such tasks include alignment to another reference frame, machining, alignment for forming or shaping an article, masking and labeling.

In another aspect, the methods include providing a composition including one or more sensitizers and one or more photoreducing agents; applying the composition to a work piece; selectively exposing the composition to energy at powers of 5 mW or less to affect a color or shade change and to form an image on the composition; selectively removing a portion of the composition based on the image to expose portions of the work piece; and executing one or more tasks on the work piece based on the portion of the composition removed from the work piece. The imaged composition may be removed from the work piece with strippers, developers, or peeled.

In a further aspect, the methods include providing a composition including one or more sensitizers and one or more photoreducing agents; applying the composition to a work piece; selectively applying energy at powers of 5 mW or less to affect a color or shade change to form an image on the composition; peeling a portion of the composition from the work piece based on the selective imaging to expose a portion of the work piece; and executing one or more tasks on the exposed portion of the work piece.

The work piece may include parts for articles of manufacture such as aeronautical ships, marine vessels, terrestrial vehicles, terrestrial structures, subterranean structures, textiles, toys and biological organisms. The work piece may include materials composed of metal, wood, ceramics, cement, stone, plaster, and natural and synthetic polymers and fibers.

Since the compositions may be promptly applied to the work piece and the image promptly formed by application of energy at intensities of 5 mW or less to create a color or shade contrast, workers no longer need to be adjacent the work piece to form images with a hand-held marker or tape in the fabrication of articles. Accordingly, the problems of blocking light caused by the movement of workers hands and the slower and tedious processes of applying marks by workers using a hand-held marker or tape is eliminated. Further, the low intensities of energy eliminate or at least reduce the potential for opthalmological damage to workers. Also, the reduction of human error increases the accuracy of marking.

As used throughout this specification, the following abbreviations have the following meaning, unless the context indicates otherwise: ° C.=degrees Centigarde; IR=infrared; UV=ultraviolet; gm=gram; mg=milligram; L=liter; mL=milliliter; wt %=weight percent; erg=1 dyne cm=10⁻⁷ joules; J=joule; mJ=millijoule; nm=nanometer=10⁻⁹ meters; cm=centimeters; mm=millimeters; W=watt=1 joule/second; and mW=milliwatt; ns=nanosecond; μsec=microsecond; Hz=hertz; KV=kilivolt.

The terms “polymer” and “copolymer” are used interchangeably throughout this specification. “Actinic radiation” means radiation from light that produces a chemical change. “Photofugitive response” means that the application of energy causes a colored material to fade or become lighter. “Phototropic response” means that the application of energy causes material to darken. “Changing shade” means that the color fades, or becomes darker. “(Meth)acrylate” includes both methacrylate and acrylate, and “(meth)acrylic acid” includes both methacrylic acid and acrylic acid. “Diluent” means a carrier or vehicle, such as solvents or solid fillers. “Opacity” means the property of being impervious to light rays, i.e. not transparent or tanslucent. “Opaque” means nontransparent and nontranslucent. “Translucent” means semitransparent. “Transparent” means a passage of rays of the visible spectrum.

Unless otherwise noted, all percentages are by weight and are based on dry weight or solvent free weight. All numerical ranges are inclusive and combinable in any order, except where it is logical that such numerical ranges are constrained to add up to 100%.

Methods include providing a composition including one or more sensitizers and one or more photoreducing agents; applying the composition to a work piece; exposing the composition to energy at powers of 5 mW or less to affect a color or shade change and to form an image on the composition; and executing one or more tasks on the work piece based on the image. Such tasks include, but are not limited to, alignment to another reference frame, machining, alignment for forming or shaping an article, masking and labeling. The image may be 1 dimensional, 2 dimensional or 3 dimensional.

Alignment to another reference includes, but is not limited to, application of the imaging compositions to biological organisms such as humans and animals. The imaging composition may be applied to the human or animal work piece followed by selectively exposing the work piece to energy to cause a color or shade change. The portions of the imaging composition of color or shade change indicate points where the human or animal is to be treated by X-rays or medical workers. The points of color or shade change may indicate a pattern of X-rays to be applied to the work piece at numerous points for treating tumors, or points of primary, secondary and tertiary examination during CAT scanning, or for designating points for surgical incisions in tissues for treatment of the internal organs, removal of adipose tissue, autopsies, dissections in general, or for points of insertion of biopsy instruments in biopsy procedures, or insertion of catheters. Imaging patterns also may be used to designate points of tissue incisions or extractions for cosmetic surgery.

Machining includes, but is not limited to, drilling, cutting, milling, punch and laser ablation. Alignment for forming or shaping includes, but is not limited to, scoring and bending of the work piece.

The imaging compositions also may be used to form a template or mask on a work piece such as for painting, etching, sandblasting, staining and layering the work piece. For example, the imaging composition may be applied to a work piece and selectively imaged using a source of energy of powers of 5 mW or less. A portion of the image may be removed exposing the work piece, while the rest of the imaging composition remaining on the work piece functions as a mask. The exposed portion may then be painted to form a pattern, symbol, sign or logo on the work piece, or sandblasted to clean the exposed portion of the work piece. The exposed portion also may be etched with an etching composition. After the task is completed the remaining portions of the imaging composition remaining on the work piece may be removed. Masks may be formed on any suitable material such as, but not limited to, metal, wood, polymers, ceramics, concrete, plaster, synthetic materials in general and stone.

Labeling includes, but is not limited to, locating object placement, relevant instructions and warning labels. For example, the imaging compositions may be applied to work pieces such as floors in the design for floor plans for placing articles such as doors, furniture, lamps, fixtures and other articles in office buildings, prefabricated houses, buildings for low income housing and military housing. The floors may be marked with the imaging compositions to designate the placement of doors, furniture, lighting and fixtures. The imaged material may be removed thereafter. Additionally, containers may be marked with the marking compositions to indicate contents including warning labels indicating hazardous materials. Also the imaging compositions may be used for mapping and diagramming.

The methods may be used to form images on parts used for making various articles such as, but not limited to, aeronautical ships, interplanetary vessels, marine vessels, terrestrial vehicles, subterranean vehicles, terrestrial structures, subterranean structures, textiles and toys.

Examples of aeronautical ships include aircraft in general including winged and un-winged as well as motorized and un-motorized, commercial aircraft, private aircraft, gliders, dirigibles, military aircraft such as fighter planes, bombers, missiles, helicopters, unmanned aircraft; examples of interplanetary vessels include aerospace craft such as rocket ships, space stations, space shuttles, satellites, extra-terrestrial reconnaissance vehicles and surface analysis vehicles; examples of terrestrial vehicles including motorized and unmotorized such as automobiles, trucks, recreational vehicles, off-road vehicles, scooters, bicycles, motorcycles, mopeds, trains, military vehicles such as armored vehicles including tanks, and personnel carriers, artillery, self-propelled artillery, reconnaissance vehicles and amphibious vehicles; examples of marine vessels include motorized and wind-powered ships, boats, catamarans, and hydrofoils; examples of subterranean vehicles include vehicles for mining; examples of terrestrial structures include buildings in general, including commercial buildings and warehouses, houses, modular houses, apartment buildings, trailer houses, military housing, bridges, dams, and furniture; examples of subterranean structures include mines, sewers and tunnels; and examples of textiles include clothing, blankets, carpets, rugs and flags.

The imaging compositions may be applied to any suitable material for marking. Such materials include, but are not limited to, metal, wood, natural and synthetic polymers, ceramics, concrete, plaster, stone, natural and synthetic fibers.

The imaging compositions may be applied to a work piece by any suitable method such as, but not limited to, spray coating, brushing, roller coating, dipping, immersing, syringe, ink jetting and pressure sensitive adhesion. The compositions may be removed by peeling from the work piece, or a suitable developer or stripper may be used. Such developers or strippers may be conventional aqueous base or organic developers and strippers. Typically, the compositions are peeled from the work piece.

Sensitizers are compounds which are activated by energy to change color or shade, or upon activation cause one or more other compounds to change color or shade. The imaging compositions include one or more photosensitizers sensitive to visible light and may be activated with energy at powers of 5 mW or less. Generally, such sensitizers are included in amounts of from 0.005 wt % to 10 wt %, or such as from 0.05 wt % to 5 wt %, or such as from 0.1 wt % to 1 wt % of the imaging composition.

Sensitizers, which are activated in the visible range, typically are activated at wavelengths of from above 300 nm to less than 600 nm, or such as from 350 nm to 550 nm, or such as from 400 nm to 535 nm. Such sensitizers include, but are not limited to cyclopentanone based conjugated compounds such as cyclopentanone, 2,5-bis-[4-(diethylamino)phenyl]methylene]-, cyclopentanone, 2,5-bis[(2,3,6,7-tetrahydro-1H,5H-benzo[i,j]quinolizin-9-yl)methylene]-, and cyclopentanone, 2,5-bis-[4-(diethyl-amino)-2-methylphenyl]methylene]-. Such cyclopentanones may be prepared from cyclic ketones and tricyclic aminoaldehydes by methods known in the art.

Examples of such suitable conjugated cyclopentanones have the following formula: 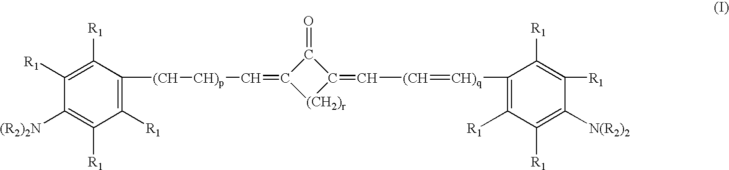
where p and q independently are 0 or 1, r is 2 or 3; and R₁ is independently hydrogen, linear or branched (C₁-C₁₀)aliphatic, or linear or branched (C₁-C₁₀)alkoxy, typically R₁ is independently hydrogen, methyl or methoxy; R₂ is independently hydrogen, linear or branched (C₁-C₁₀)aliphatic, (C₅-C₇)ring, such as an alicyclic ring, alkaryl, phenyl, linear or branched (C₁-C₁₀)hydroxyalkyl, linear or branched hydroxy terminated ether, such as —(CH₂)ᵥ—O—(CHR₃)_{w}—OH, where v is an integer of from 2 to 4, w is an integer of from 1 to 4, and R₃ is hydrogen or methyl and carbons of each R₂ may be taken together to form a 5 to 7 membered ring with the nitrogen, or a 5 to 7 membered ring with the nitrogen and with another heteroatom chosen from oxygen, sulfur, and a second nitrogen. Such sensitizers may be activated at intensities of 5 mW or less.

Other sensitizers which are activated in the visible light range include, but are not limited to, N-alkylamino aryl ketones such as bis(9-julolidyl ketone), bis-(N-ethyl-1,2,3,4-tetrahydro-6-quinolyl)ketone and p-methoxyphenyl-(N-ethyl-1,2,3,4-tetrahydro-6-quinolyl)ketone; visible light absorbing dyes prepared by base catalyzed condensation of an aldehyde or dimethinehemicyanine with the corresponding ketone; visible light absorbing squarylium compounds; 1,3-dihydro-1-oxo-2H-indene derivatives; coumarin based dyes such as ketocoumarin, and 3,3′-carbonyl bis(7-diethylaminocoumarin); halogenated titanocene compounds such as bis(eta.5-2,4-cyclopentadien-1-yl)-bis(2,6-difluro-3-(1H-pyrrol-1-yl)-phenyl) titanium; and compounds derived from aryl ketones and p-dialkylaminoarylaldehydes. Examples of additional sensitizers include fluorescein type dyes and light absorber materials based on the triarylmethane nucleus. Such compounds include Eosin, Eosin B, and Rose Bengal. Another suitable compound is erythrosin B. Methods of making such sensitizers are known in the art, and many are commercially available. Typically, such visible light activated sensitizers are used in amounts of from 0.05 wt % to 2 wt %, or such as from 0.25 wt % to 1 wt %, or such as from 0.1 wt % to 0.5 wt % of the composition.

Optionally, the imaging compositions may include one or more photosensitizers that are activated by UV light. Such sensitizers which are activated by UV light are typically activated at wavelengths of from above 10 nm to less than 300 nm, or such as from 50 nm to 250 nm, or such as from 100 nm to 200 nm. Such UV activated sensitizers include, but are not limited to, polymeric sensitizers having a weight average molecular weight of from 10,000 to 300,000 such as polymers of 1-[4-(dimethylamino)phenyl]-1-(4-methoxyphenyl)-methanone, 1-[4-(dimethylamino)phenyl]-1-(4-hydroxyphenyl)-methanone and 1-[4-(dimethylamino)phenyl]-1-[4-(2-hydroxyethoxy)-phenyl]-methanone; free bases of ketone imine dyestuffs; amino derivatives of triarylmethane dyestuffs; amino derivatives of xanthene dyestuffs; amino derivatives of acridine dyestuffs; methine dyestuffs; and polymethine dyestuffs. Methods of preparing such compounds are known in the art. Typically, such UV activated sensitizers are used in amounts of from 0.05 wt % to 1 wt %, or such as from 0.1 wt % to 0.5 wt % of the composition.

Optionally, the imaging compositions may include one or more photosensitizers that are activated by IR light. Such sensitizers which are activated by IR light are typically activated at wavelengths of from greater than 600 nm to less than 1,000 nm, or such as from 700 nm to 900 nm, or such as from 750 nm to 850 nm. Such IR activated sensitizers include, but are not limited to infrared squarylium dyes, and carbocyanine dyes. Such dyes are known in the art and may be made by methods described in the literature. Typically, such dyes are included in the compositions in amounts of from 0.05 wt % to 3 wt %, or such as from 0.5 wt % to 2 wt %, or such as from 0.1 wt % to 1 wt % of the composition.

Photoreducing agents used in the imaging compositions include, but are not limited to, one or more quinone compounds such as pyrenequinones such as 1,6-pyrenequinone and 1,8-pyrenequinone; 9,10-anthrquinone, 1-chloroanthraquinone, 2-chloro-anthraquinone, 2-methylanthrquinone, 2-ethylanthraquinone, 2-tert-butylanthraquinone, octamethylanthraquinone, 1,4-naphthoquinone, 9,10-phenanthrenequinone, 1,2-benzaanthrquinone, 2,3-benzanthraquinone, 2-methyl-1,4-naphthoquinone, 2,3-dichloronaphthoquinone, 1,4-dimethylanthraquinone, 2,3-dimethylanthraquinone, sodium salt of anthraquinone alpha-sulfonic acid, 3-chloro-2-methylanthraquinone, retenequinone, 7,8,9,10-tetrahydronaphthacenequinone, and 1,2,3,4-tetrahydrobenz(a)anthracene-7,12-dione.

Other compounds which may function as photoreducing agents include, but are not limited to, acyl esters of triethanolamines having a formula:
N(CH₂CH₂OC(O)—R)₃ (II)
where R is alkyl of 1 to 4 carbon atoms, and 0 to 99% of a C₁ to C₄ alkyl ester of nitrilotriacetic acid or of 3,3′,3″-nitrilotripropionic acid. Examples of such acyl esters of triethanolamine are triethanolamine triacetate and dibenzylethanolamine acetate.

One or more photoreducing agents may be used in the imaging compositions to provide the desired color or shade change. Typically, one or more quinones are used with one or more acyl ester of triethanolamine to provide the desired reducing agent function. Photoreducing agents may be used in the compositions in amounts of from 0.05 wt % to 50 wt %, or such as from 5 wt % to 40 wt %, or such as 20 wt % to 35 wt %.

Suitable color formers include, but are not limited to, leuco-type compounds. Such leuco-type compounds include, but are not limited to, aminotriarylmethanes, aminoxanthenes, aminothioxanthenes, amino-9,10-dihydroacridines, aminophenoxazines, aminophenothiazines, aminodihydrophenazines, antinodiphenylmethines, leuco indamines, aminohydrocinnamic acids such as cyanoethanes and leuco methines, hydrazines, leuco indigoid dyes, amino-2,3-dihydroanthraquinones,tetrahalo-p,p′-biphenols, 2(p-hydroxyphenyl)-4,5-diphenylimidazoles, and phenethylanilines. Typically, the aminotriarylmethane leuco dyes are used. More typically, the o-methyl substituted aminotriarylmethanes are used. Leuco-type compounds are included in amounts of from 0.1 wt % to 5 wt %, or such as from 0.25 wt % to 3 wt %, or such as from 0.5 wt % to 2 wt % of the composition.

Oxidizing agents also may be included in the imaging compositions to influence the color or shade change. Typically such oxidizing agents are used in combination with one or more color formers. Such compounds include, but are not limited to, hexaarylbiimidazole compounds such as 2,4,5,2′,4′,5′-hexaphenylbiimidazole, 2,2′,5-tris(2-chlorophenyl)-4-(3,4-dimethoxyphenyl)-4,5-diphenylbiimidazole (and isomers), 2,2′-bis(2-ethoxyphenyl)-4,4′,5,5′,-tetraphenyl-1,1′-bi-1H-mimidazole, and 2,2′-di-1-naphthalenyl-4,4′,5,5′-tetraphenyl-1′-bi-1H-imidazole. imidazole. Other suitable compounds include, but are not limited to, halogenated compounds with a bond dissociation energy to produce a first halogen as a free radical of not less than 40 kilocalories per mole, and having not more than one hydrogen attached thereto; a sulfonyl halide having a formula: R′—SO₂—X where R′ is an alkyl, alkenyl, cycloalkyl, aryl, alkaryl, or aralkyl and X is chlorine or bromine; a sulfenyl halide of the formula: R″—S—X′ where R″ and X′ have the same meaning as R′ and X above; tetraaryl hydrazines, benzothiazolyl disulfides, polymetharylaldehydes, alkylidene 2,5-cyclohexadien-1-ones, azobenzyls, nitrosos, alkyl (T1), peroxides, and haloamines. Oxidizing agents are included in the compositions in amounts of from 0.25 wt % to 10 wt %, or such as from 0.5 wt % to 5 wt %, or such as from 1 wt % to 3 wt % of the composition.

Film forming polymers may be included in the imaging compositions to function as binders for the compositions. Any film forming binder may be employed in the formulation of the compositions provided that the film forming polymers do not adversely interfere with the desired color or shade change. The film forming polymers are included in amounts of 10 wt % to 90 wt %, or such as from 15 wt % to 70 wt %, or such as from 25 wt % to 60 wt % of the compositions. Typically, the film forming polymers are derived from a mixture of acid functional monomers and non-acid functional monomers. The acid and non-acid functional monomers are combined to form copolymers such that the acid number ranges from at least 80, or such as from 150 to 250. Examples of suitable acid functional monomers include (meth)acrylic acid, maleic acid, fumaric acid, citraconic acid, 2-acrylamido-2-methylpropanesulfonic acid, 2-hydroxyethyl acrylol phosphate, 2-hydroxypropyl acrylol phosphate, and 2-hydroxy-alpha-acrylol phosphate.

Examples of suitable non-acid functional monomers include esters of (meth)acrylic acid such as methyl acrylate, 2-ethyl hexyl acrylate, n-butyl acrylate, n-hexyl acrylate, methyl methacrylate, hydroxyl ethyl acrylate, butyl methacrylate, octyl acrylate, 2-ethoxy ethyl methacrylate, t-butyl acrylate, 1,5-pentanediol diacrylate, N,N-diethylaminoethyl acrylate, ethylene glycol diacrylate, 1,3-propanediol diacrylate, decamethylene glycol diacrylate, decamethylene glycol dimethacrylate, 1,4-cyclohexanediol diacrylate, 2,2-dimethyylol propane diacrylate, glycerol diacrylate, tripropylene glycol diacrylate, glycerol triacrylate, 2,2-di(p-hydroxyphenyl)-propane dimethacrylate, triethylene glycol diacrylate, polyoxyethyl-2,2-di(p-hydroxyphenyl)-propane dimethacrylate, triethylene glycol dimethacrylate, polyoxypropyltrimethylol propane triacrylate, ethylene glycol dimethacrylate, butylenes glycol dimethacrylate, 1,3-propanediol dimethacrylate, 1,2,4-butanetriol trimethacrylate, 2,2,4-trimethyl-1,3-pentanediol dimethacrylate, pentaerythritol trimethacrylate, 1-phenyl ethylene-1,2-dimethacrylate, pentaerythritol tetramethacrylate, trimethylol propane trimethacrylate, 1,5-pentanediol dimethacrylate; styrene and substituted styrene such as 2-methyl styrene and vinyl toluene and vinyl esters such as vinyl acrylate and vinyl methacrylate.

Other suitable polymers include, but are not limited to, nonionic polymers such as polyvinyl alcohol, polyvinyl pyrrolidone, hydroxyl-ethylcellulose, and hydroxyethylpropyl methylcellulose.

Chain transfer agents may be used in the imaging compositions. Such chain transfer agents function as accelerators. One or more chain transfer agents may be used in the imaging compositions. Chain transfer agents or accelerators increase the rate at which the color or shade change occurs after exposure of energy. Any compound which accelerates the rate of color or shade change may be used. Accelerators may be included in the compositions in amounts of 0.01 wt % to 25 wt %, or such as from 0.5 wt % to 10 wt %. Examples of suitable accelerators include onium salts, and amines.

Suitable onium salts include, but are not limited to, onium salts in which the onium cation is iodonium or sulfonium such as onium salts of arylsulfonyloxybenzenesulfonate anions, phosphonium, oxysulfoxonium, oxysulfonium, sulfoxonium, ammonium, diazonium, selononium, arsonium, and N-substituted N-heterocyclic onium in which N is substituted with a substituted or unsubstituted saturated or unsaturated alkyl or aryl group.

The anion of the onium salts may be, for example, chloride, or a non-nucleophilic anion such as tetrafluoroborate, hexafluorophosphate, hexafluoroarsenate, hexafluoroantimonate, triflate, tetrakis-(pentafluorophosphate) borate, pentafluoroethyl sulfonate, p-methyl-benzyl sulfonate, ethylsulfonate, trifluoromethyl acetate and pentafluoroethyl acetate.

Examples of typical onium salts include, for example, diphenyl iodonium chloride, diphenyliodonium hexafluorophosphate, diphenyl iodonium hexafluoroantimonate, 4,4′-dicumyliodonium chloride, dicumyliodonium hexafluorophosphate, N-methoxy-a-picolinium-p-toluene sulfonate, 4-methoxybenzene-diazonium tetrafluoroborate, 4,4′-bis-dodecylphenyliodonium-hexafluoro phosphate, 2-cyanoethyl-triphenylphosphonium chloride, bis-[4-diphenylsulfonionphenyl]sulfide-bis-hexafluoro phosphate, bis-4-dodecylphenyliodonium hexafluoroantimonate and triphenylsulfonium hexafluoroantimonate.

Suitable amines include, but are not limited to primary, secondary and tertiary amines such as methylamine, diethylamine, triethylamine, heterocyclic amines such as pyridine and piperidine, aromatic amines such as aniline, quaternary ammonium halides such as tetraethylammonium fluoride, and quaternary ammonium hydroxides such as tetraethylammonium hydroxide.

Plasticizers also may be included in the compositions. Any suitable plasticizer may be employed. Plasticizers may be included in amounts of from 0.5 wt % to 15 wt %, or such as from 1 wt % to 10 wt % of the compositions. Examples of suitable plasticizers include phthalate esters, glycols, phosphate esters, amides, aliphatic dibasic acid esters, and glycerine triacetylesters.

One or more flow agents also may be included in the compositions. Flow agents are compounds, which provide a smooth and even coating over a substrate. Flow agents may be included in amounts of from 0.05 wt % to 5 wt % or such as from 0.1 wt % to 2 wt % of the compositions. Suitable flow agents include, but are not limited to, copolymers of alkylacrylates.

Optionally, one or more organic acids may be employed in the imaging compositions. Organic acids may be used in amounts of from 0.1 wt % to 5 wt %, or such as from 0.5 wt % to 2 wt %. Examples of suitable organic acids include formic acid, acetic acid, propionic acid, butyric acid, valeric acid, caproic acid, caprylic acid, capric acid, lauric acid, phenylacetic acid, benzoic acid, phthalic acid, isophthalic acid, terephthalic acid, adipic acid, 2-ethylhexanoic acid, isobutyric acid, 2-methylbutyric acid, 2-propylheptanoic acid, 2-phenylpropionic acid, 2-(p-isobutylphenyl)propionic acid, and 2-(6-methoxy-2-naphthyl)propionic acid.

Optionally, one or more surfactants may be used in the imaging compositions. Surfactants may be included in the compositions in amounts of from 0.1 wt % to 10 wt %, or such as from 0.25 wt % to 5 wt %, or such as from 0.5 wt % to 4 wt % of the composition. Suitable surfactants include non-ionic, ionic and amphoteric surfactants. Examples of suitable non-ionic surfactants include polyethylene oxide ethers, derivatives of polyethylene oxides, aromatic ethoxylates, acetylenic ethylene oxides and block copolymers of ethylene oxide and propylene oxide. Examples of suitable ionic surfactants include alkali metal, alkaline earth metal, ammonium, and alkanol ammonium salts of alkyl sulfates, alkyl ethoxy sulfates, and alkyl benzene sulfonates. Examples of suitable amphoteric surfactants include derivatives of aliphatic secondary and tertiary amines in which the aliphatic radical may be straight chain or branched and where one or the aliphatic substituents contains from 8 to 18 carbon atoms and one contains an anionic water solubilizing group such as carboxy, sulfo, sulfato, phosphate, or phosphono. Specific examples of such amphoteric surfactants are sodium 3-dodecylaminopropionate and sodium 3-dodecylaminopropane sulfonate.

Other suitable amphoteric surfactants include, but are not limited to, amphoteric surfactants which have weakly acidic functionalities such as carboxy functionalities and have isoelectric points of pH 3 to pH 8. Such amphoteric surfactants are included in the compositions as release agents for a peelable formulation. Such amphoteric surfactants include, but are not limited to, amino carboxylic acids, amphoteric imidazoline derivatives, betaines, fluorocarbon and siloxane versions thereof and mixtures thereof. Such amphoteric surfactants are included in the imaging compositions to make them peelable without an additional adhesive layer.

Suitable aminocarboxylic acids include, but are not limited to: α-aminocarboxylic acids having the general formula R₁₂—NH—CH₂COOH, where R₁₂=C₄-C₂₀ linear or branched, alkyl, alkenyl, or fluoro or silicone functional hydrophobe groups; and β-aminocarboxylic acids having the general structures: R₁₂—NH—CH₂CH₂COOH and R₁₂N(CH₂CH₂COOH)₂, where R₁₂=C₄-C₂₀ linear or branched, alkyl, alkenyl, or fluoro or silicone functional hydrophobe group. β-aminocarboxylic acids are available from Henkel Corporation, King of Prussia, Pa., under the name DERIPHAT™. Unless otherwise stated, the DERIPHAT™ ampholytes have the general formula R₁₃—NHCH₂CH₂COOH, where R₁₃=residue of coconut fatty acids, residue of tallow fatty acids, lauric acid, myristic acid, oleic acid, palmitic acid, stearic acid, linoleic acid, other C₄-C₂₀ linear or branched, alkyl, alkenyl, and mixtures thereof DERIPHAT™ ampholytes useful in the present invention include: sodium-N-coco-β-aminopropionate (DERIPHAT™ 151, flake 97% active); N-coco-β-aminoproprionic acid (DERIPHAT™ 151C, 42% solution in water); N-lauryl/myristyl-β-aminopropionic acid (DERIPHAT™ 17° C., 50% in water); disodium-N-tallow-β-iminoproprionate, R₁₄N(CH₂CH₂COONa)₂, (DERIPHAT™ 154, flake 97% active); disodium-N-lauryl-β-iminodipropionate (DERIPHAT™ 160, flake 97% active); and partial sodium salt of N-lauryl-β-iminodipropionic acid, R₁₄N(CH₂CH₂COOH)(CH₂CH₂COONa), (DERIPHAT™ 16° C., 30% in water). Useful polyamino carboxylic acids also include R₁₄C(═O)NHC₂H₄(NHC₂H₄)_{y}NHCH₂COOH and R₁₄-substituted ethylenediaminetetraacetic acid (EDTA), where R₁₄=C₄-C₂₀ linear or branched, alkyl or alkenyl, and y=0 to 3.

Amphoteric imidazoline derivatives useful include those derived from substituted 2-alkyl-2-imidazolines and 2-alkenyl-2-imidazoline which have nitrogen atoms at the 1 and 3 positons of the fine-membered ring and a double bond in the 2, 3-position. The alkyl or alkenyl group may be a C₄-C₂₀ linear or branched chain. The amphoteric imidazoline derivatives are produced via reactions in which the imidazoline ring opens hydrolytically under conditions allowing further reaction with such alkylating agents as sodium chloroacetate, methyl(meth)acrylate, ethyl(meth)acrylate and (meth)acrylic acid. Useful amphoteric surfactants derived from the reaction of 1-(2-hydroxyethyl)-2-(R₁)-2-imidazolines with acrylic acid or acrylic acid esters, where R₁₅=residue coconut fatty acids, include, but are not limited to: cocoamphopropionate, R₁₅—C(═O)NHCH₂CH₂N(CH₂CH₂OH)(CH₂CH₂COONa); cocoamphocarboxypropionic acid, R₁₅—C(═O)NHCH₂CH₂N(CH₂CH₂COOH)(CH₂CH₂CH₂₀CH₂COONa); cocoamphoglycine, R₁₅—C(═O)NHCH₂CH₂N(CH₂CH₂₀CH₂)(CH₂COONa); and cocoamphocarboxyglycinate, [R₁₅—C(═O)NHCH₂CH₂CH₂N⁺(CH₂CH₂OH)(CH₂COONa)₂]OH⁻.

Surface-active inner salts containing at least one quaternary ammonium cation and at least one carboxy anion are called betaines. Betaines useful as amphoteric surfactants include, but are not limited to, compounds of the general formula: R₁₆N⁺(CH₃)₂CH₂COO⁻; R₁₆CONHCH₂CH₂CH₂N⁺(CH₃)₂CH₂COO⁻; and R₁₆—O—CH₂—N⁺(CH₃)₂CH₂COO⁻, where R₁₆=C₄-C₂₀ linear or branched, alkyl, alkenyl, or fluoro or silicone functional hydrophobe group. Examples of betaines include N-dodocyl-N,N-dimethylglycine and cocoamidopropyl betaine and MONATERIC™ CAB available from Mona Industries.

Typically, when fluorocarbon substituents are attached to amphoteric surfactants, those substituents are perfluoroalkyl groups, branched or unbranched, having 6 to 18 carbon atoms. However, these substituents may instead be partially fluorinated. They may also bear aryl functionality. Examples of fluorocarbon amphoteric surfactants include, but are not limited to, fluorinated alkyl FLUORAD™ FC100 and fluorinated alkyl ZONYL™ FSK, produced by 3M and Du Pont respectively.

Siloxane functional surfactants also may be used. An example of a siloxane surfactant is the polyalkyl betaine polysiloxane copolymer ABIL™ B9950 available from Goldschmidt Chemical Corporation.

Macromolecular amphoteric surfactants useful include, but are not limited to: proteins, protein hydrolysates, derivatives of protein hydrolysates, starch derivatives and synthetic amphoteric oligomers and polymers. Typically, macromolecular ampholytes bearing carboxy functionality are useful.

Typically, the imaging compositions are within a pH range of 3 to 11, or such as from 4 to 7. Optionally, a base may be employed to maintain the desired pH. Such bases include, but are not limited to, calcium carbonate, zinc oxide, magnesium oxide, calcium hydroxide or mixtures thereof. Bases may be present in the imaging compositions in amounts of greater than 0.2 moles/100 gm of polymer to 2 moles/100 gm of polymer, or such as from 0.3 moles/100 gm of polymer to 1.75 moles/100 gm of polymer, or such as from 0.4 moles/100 gm of polymer to 1.5 moles/100 gm of polymer.

Optionally, polyvalent metal cations may be included to form an ionic bond with a carboxylic acid group on one or more of the monomers which compose the polymers. Any suitable polyvalent cation may be used which forms an ionic bond with the carboxylic acid groups to achieve cross-linking. Such cations include, but are not limited to, Mg²⁺, Sr²⁺, Ba²⁺, Ca²⁺, Zn²⁺, Al³⁺, Zr⁴⁺ or mixtures thereof. Such polyvalent cations are included in the imaging compositions in amounts of 0.001 to 0.1 moles/100 gm of dry polymer, or such as from 0.01 to 0.08 moles/100 gm of dry polymer, or such as from 0.02 to 0.05 moles/100 gm of dry polymer.

When one or more bases containing polyvalent cations are included in combination with another source of polyvalent cations, the sum of the amounts of base and polyvalent metal cation is greater than 0.2 to 2 moles/100 gm of polymer, or such as from 0.3 to 1.75 moles/100 gm of polymer, or such as from 0.4 to 1.5 moles/100 gm of polymer.

Optionally, one or more antioxidants may be included in the composition to stabilize the color or shade change to ambient radiation. Any suitable antioxidant which arrests the oxidation of color formers may be used. Such antioxidants include, but are not limited to, hindered phenols and hindered amines. Hindered phenols include one or two sterically bulky groups bonded to the carbon atom or atoms contiguous to a hydroxyl group-bonded carbon atom to sterically hinder the hydroxyl group. Hindered amines include one or two sterically bulky groups bonded to the carbon atom or atoms adjacent to a nitrogen atom to sterically hinder the nitrogen. The nitrogen itself may have bulky groups bonded to it. The antioxidants may be micro-encapsulated in polymers such as, but not limited to, polyurethanes, polyureas, polyamides, polyesters, polycarbonates and combinations thereof.

Thickeners may be included in the imaging compositions in conventional amounts. Any suitable thickener may be incorporated in the imaging compositions. Typically, thickeners range from 0.05 wt % to 10 wt %, or such as from 1 wt % to 5 wt % of the compositions. Conventional thickeners may be employed. Examples of suitable thickeners include low molecular weight polyurethanes such as having at least three hydrophobic groups interconnected by hydrophilic polyether groups. The molecular weight of such thickeners ranges from 10,000 to 200,000. Other suitable thickeners include hydrophobically modified alkali soluble emulsions, hydrophobically modified hydroxyethyl cellulose and hydrophobically modified polyacrylamides.

Rheology modifiers may be included in conventional amounts. Typically rheology modifiers are used in amounts of from 0.5 wt % to 20 wt %, or such as from 5 wt % to 15 wt % of the compositions. Examples of rheology modifiers include vinyl aromatic polymers and acrylic polymers.

Diluents may be included in the imaging compositions to provide a vehicle or carrier for the other components. Diluents are added as needed. Solid diluents or fillers are typically added in amounts to bring the dry weight of the compositions to 100 wt %. Examples of solid diluents are celluloses. Liquid diluents or solvents are employed to make solutions, suspensions, dispersions or emulsions of the active components of the compositions. The solvents may be aqueous or organic, or mixtures thereof. Examples of organic solvents include alcohols such as methyl, ethyl and isopropyl alcohol, diisopropyl ether, diethylene glycol dimethyl ether, 1,4-dioxane, tetrahydrofuran or 1,2-dimethoxy propane, and esters such as butyrolactone, ethylene glycol carbonate and propylene glycol carbonate, an ether esters such as methoxyethyl acetate, ethoxyethyl acetate, 1-methoxypropyl-2-acetate, 2-methoxypropyl-1-acetate, 1-ethoxypropyl-2-acetate and 2-ethoxypropyl-1-acetate, ketones such as acetone and methylethyl ketone, nitriles such as acetonitrile, propionitrile and methoxypropionitrile, sulfones such as sulfolan, dimethylsulfone and diethylsulfone, and phosphoric acid esters such as trimethyl phosphate and triethyl phosphate.

The imaging compositions may be in the form of a concentrate. In such concentrates, the solids content may range from 80 wt % to 98 wt %, or such as from 85 wt % to 95 wt %. Concentrates may be diluted with water, one or more organic solvents, or a mixture of water and one or more organic solvents. Concentrates may be diluted such that the solids content ranges from 5 wt % to less than 80 wt %, or such as from 10 wt % to 70 wt %, or such as from 20 wt % to 60 wt %.

In another aspect, the imaging compositions may be applied to a film substrate with an adhesive and the article including the imaging composition and the adhesive applied to the work piece. The adhesive may be a permanent adhesive, semi-permanent, a repositonable adhesive, a releasable adhesive, or freezer category adhesive. The adhesives may be hot-melt, hot-melt pressure sensitive or pressure sensitive. Typically, the releasable adhesives are pressure sensitive adhesives. Examples of such releasable adhesives include adhesives include acrylics, polyurethanes, poly-alpha-olefins, silicones, combinations of acrylate pressure sensitive adhesives and thermoplastic elastomer-based pressure sensitive adhesives, and tackified natural and synthetic rubbers.

Examples of materials for the film substrate include polyolefins such as polyethylene including high, low, linear low and linear ultra low density polyethylene, polypropylene and polybutylenes; vinyl copolymers such as polyvinyl chlorides, both plasticized and unplasticized, and polyvinyl acetates; olefinic copolymers such as ethylene/methacrylate copolymers, ethylene/vinyl acetate copolymers, acrylonitrile-butadiene-styrene copolymers, andethylene/propylene copolymers; acrylic polymers and copolymers; cellulose; polyesters; and combinations of the foregoing mixtures, or blends of any plastic or plastic elastomeric materials such as polypropylene/polyethylene, polyurethane/polyolefin, polyurethane/polycarbonate, polyurethane/polyester also may be used.

The adhesive side of the article may have a removable release layer, which protects the adhesive from the environment prior to application of the article to a work piece. Examples of removable release layers include cellulose, polymers and copolymers of polyesters, polyurethanes, vinyl copolymers, polyolefins, polycarbonates, polyamides, polyimides, epoxy polymers and combinations thereof.

A protective polymer layer may be placed over the imaging composition on the film substrate. The protective polymer layer may be of the same material as the substrate.

In another aspect, a peelable, opaque coating is placed on the work piece prior to the application of the peelable imaging composition. The peelable, opaque coating prevents any undesired chemical interactions between any coatings on the work piece and the imaging compositions. One such problem is the leaching of dyes from the peelable imaging composition into epoxy coatings on the work piece. In addition to preventing undesired chemical reactions between the imaging composition and the coatings on the work piece, opacifying compounds in the opaque coating increase the photospeed of the color or shade change by a factor of Δ+0.5 to +1.5 as measured by a reflection densitometer.

The peelable, opaque coatings include one or more opacifying compounds such as organic or inorganic pigments, metal salts, silica, silicates and clays in amounts of 1 wt % to 40 wt %, or such as from 5 wt % to 30 wt %, or such as from 10 wt % to 20 wt %. Typically inorganic pigments are used such as metal oxides. Examples of such metal oxides include titanium dioxide, zinc oxide, zirconium oxide, ceric oxide, antimony trioxide, arsenic pentoxide, aluminum oxide, cobalt oxide, magnesium oxide, cadmium oxide, chromium oxide and lead oxide. More typically titanium dioxide, zinc oxide and aluminum oxide are used.

In addition to the opacifying compounds, the opaque coating also may include one or more film forming binders, one or more diluents and one or more amphoteric surfactants to function as a release agent. The opacifying coatings also may include one or more other additives to tailor the opaque coating to a particular imaging composition and work piece.

The components, which compose the imaging compositions, may be combined by any suitable method known in the art. The components may be blended or mixed together using conventional apparatus to form a solid mixture, concentrate, solution, suspension, dispersion or emulsion. The formulation process is typically performed in light controlled environments to prevent premature activation of one or more of the components. The compositions may then be stored for later application or applied promptly after formulation to a substrate by anyone of the methods discussed above. Typically the compositions are stored in light controlled environments prior to use. For example, compositions with sensitizers activated by visible light are typically formulated and stored under red light.

Upon application of a sufficient amount of energy to an imaging composition, a photofugitive or a phototropic response occurs. The amount of energy may be from 0.2 mJ/cm² and greater, or such as from 0.2 mJ/cm² to 100 mJ/cm², or such as from 2 mJ/cm² to 40 mJ/cm², or such as from 5 mJ/cm² to 30 mJ/cm².

The imaging compositions undergo color or shade changes with the application of powers of 5 mW of energy or less (i.e., greater than 0 mW), or such as from less than 5 mW to 0.01 mW, or such as from 4 mW to 0.05 mW, or such as from 3 mW to 0.1 mW, or such as from 2 mW to 0.25 mW or such as from 1 mW to 0.5 mW. Typically, such powers are generated with light sources in the visible range. Other photosensitizers and energy sensitive components, which may be included in the imaging compositions, may elicit a color or shade change upon exposure to energy from light outside the visible range. Such photosensitizers and energy sensitive compounds are included to provide a more pronounced color or shade contrast with that of the response caused by the application of 5 mW or less. Typically photosensitizers and energy sensitive compounds, which form the color or shade contrast with photosensitizers activated by energy at intensities of 5 mW or less, elicit a phototropic response.

Any suitable energy source may be used to induce the photofugitive or phototropic response. Examples of suitable energy sources include, but are not limited to, lasers, including lasers generated from hand held lasers and 3-D imaging systems, flash lamps and digital marking apparatus. Operating wavelengths of lasers may range from IR through UV.

The imaging compositions provide a rapid and efficient means of changing the color or shade of a work piece or of placing an image on a work piece. After the imaging composition is applied a sufficient amount of energy is applied to the imaging composition to change its color or shade. Generally, the color or shade change is stable. Stable means the color or shade change lasts at least 10 seconds, or such as from 20 minutes to 2 days, or such as from 30 minutes to 1 hour. Further, the reduction of human error increases the accuracy of marking. This is important when the marks are used to direct the alignment of parts.

### EXAMPLE 1

The components disclosed in the table below are mixed together at 20° C. under red light to form a homogeneous mixture.

TABLE 1

| Component | Percent Weight |
|---|---|
| Copolymer of n-hexyl methacrylate, | 55 |
| methymethacrylate, n-butyl acrylate, styrene | |
| and methacrylic acid | |
| Dipropylene glycol dibenzoate | 16 |
| Hexaarylbiimidazole | 2 |
| 9,10-Phenanthrenequinone | 0.2 |
| Triethanolamine triacetate | 1.5 |
| Leuco Crystal Violet | 0.3 |
| Cyclopentanone, 2,5-bis[[4- | 0.1 |
| (diethylamino)phenyl]methylene]-,(2E, 5E) | |
| Methyl ethyl ketone | Sufficient amount |
| | to bring formulation |
| | to 100% by weight. |

The copolymer is formed from monomers of 29 wt % n-hexyl methacrylate, 29 wt % methylmethacrylate, 15 wt % n-butyl acrylate, 5 wt % styrene, and 22 wt % methacrylic acid. A sufficient amount of methyl ethyl ketone is used to form a 45 wt % solids mixture. The copolymer is formed by conventional free-radical polymerization. After the homogenous mixture is prepared, it is spray coated on a polyethylene film 250 microns thick and air dried.

The tape is placed along the length of an aluminum airplane fuselage by workers at station 1. Under UV light the dried coating on the polyethylene film is reddish brown in color. The airplane fuselage is transferred to station 2 for selective marking of the tape. A 3D laser projection apparatus is used to selectively mark the tape. The 3D laser projection apparatus utilizes computer aided design (CAD) data for a given 3D object to produce rapidly moving vector-scan laser beam. Velocities are 114,000 cm/second at 532 nm and 5 mW. The beam selectively strikes the tape on the fuselage to cause light gray cross-hairs to form along the length of the fuselage.

The fuselage is then transported to the next station where robots drill holes at the point of the cross-hairs insertion of fasteners. The fasteners are inserted at station 4 and are used to join bulk heads to the fuselage.

### EXAMPLE 2

The components listed in the table below are mixed together at 20° C. under UV light to form a homogeneous mixture.

TABLE 2

| Components | Weight Percent |
|---|---|
| Copolymer of styrene and acrylic acid | 25 |
| Calcium Carbonate | 20 |
| Cyclopentanone-2,5-bis [[4- | 0.5 |
| (diethylamino)phenyl]methylene]- | |
| Leuco Crystal Violet | 1 |
| o-chloro-hexaarylbiimidazole | 6.5 |
| 1,2-naphthaquinone | 0.5 |
| Triethanolamine triacetate | 1.5 |
| Polyalkyl betaine polysiloxane copolymer | 2 |
| Ester Alcohol | 8 |
| Water | 35 |

The copolymers of styrene and acrylic acid are commercially available under the trade name RHOPLEX™ P-376, which is obtainable from Rohm and Haas Company. The copolymer is mixed in water with the polyalkyl betaine polysiloxane copolymer to form an aqueous suspension. Calcium carbonate is added to the suspension to maintain a pH of 8 to 11.

The imaging component: leuco crystal violet, o-chloro-hexaarylbiimidazole, 1,2-naphthaquinone, triethanolamine triacetate and cyclopentanone-2,5-bis[[4-(diethylamino)phenyl]methylene]- are mixed together in the ester alcohol TEXANOL™, which may be obtained from Eastman chemical Co., Kingsport, Tenn., to form an organic solution. The aqueous suspension is emulsified with the organic solution to form an oil in water emulsion.

The composition is used to mark sheet metal for drilling holes in and bending the metal. The process is directed by a master computer programmed for receiving a day's operation from a CAD and CAM data source. The CAD computer has a CAD terminal for receiving operator-entered design information to design a part to be fabricated. The CAD terminal is a model DN 3000 terminal available from Apollo Corporation which runs the UNISYS computer-aided design software system. The CAD terminal is connected to a manufacturing process program (MPP) computer. The MPP receives as input CAD data contained in the CAD data files of the CAD terminal. The MPP computer also receives data supplied from a Control Data Corporation Cyber 930 computer.

The MPP computer combines MPP data and CAD data to generate part description data (PDD) files, each identified by a unique part number and consisting of a plurality of part definition data records forming a complete file of all data necessary to fabricate the sheet metal. The MPP computer is a stand alone computer connected by a data link to the CAD terminal.

Each work station includes one or more robots with manipulator arms for applying the marking composition to the sheet metal, imaging the marking composition, drilling and bending the sheet metal. Each robot is connected to the data link. The sheet metal is first sent to robot station #1 where the marking composition is applied to the sheet metal. At robot station #2 the robot selectively marks the composition with a 532 nm Nd:YAG laser at 5 mW to cause a color change which designates points where the sheet metal is to be drilled for holes and lines where it is to be bent. At robot station #3 the robot drills holes at the selected points, and at robot station #4 the robot bends the sheet metal as indicated by the colored lines. At robot station #5 the marking composition is peeled from the sheet metal, and the sheet metal is sent to the next station for further processing.

### EXAMPLE 3

The following composition is prepared at 20° C. under red light.

TABLE 3

| Component | Weight Percent |
|---|---|
| Vinyl acetate/acrylic copolymer emulsion | 25 |
| 2-alkyl-2-imidazoline | 15 |
| Vinyl aromatic polymer | 5 |
| Leuco Crystal Violet | 1 |
| Tribromo methyl phenyl sulfone | 6.5 |
| 2′,4′,5′,7′-tetraiodo-3,4,5,6- | 0.5 |
| tetrachlorofluorescein disodium salt | |
| 2,2′-methylene-bis(4-methyl-6-tertbutylphenol) | 2 |
| Ethylene glycol phenyl ether | 10 |
| Water | 35 |

The vinyl acetate/acrylic copolymer emulsion used is ROVACE™ 661, which is available from Rohm and Haas Company. The copolymer, vinyl aromatic polymer and the 2-alkyl-2-imidazoline are mixed in water to form an aqueous emulsion.

The imaging components: leuco crystal violet, tribromo methyl phenyl sulfone, 2′,4′,5′,7′-tetraiodo-3,4,5,6-tetrachlorofluorescein disodium salt, and 2,2′-methylene-bis(4-methyl-6-terbutylphenol) are solubilized in ethylene glycol phenyl ether to form an organic solution. The aqueous emulsion and the organic solution are mixed to form an oil in water emulsion.

The imaging composition is used to mark panel sections, which can be used to construct structural walls, floors, ceilings and roofs to form building structures. The panels are made of wood, steel, plastic or ceramic. Processing the panels for forming building components is done on an assembly line/conveyor system. At station 1 the imaging composition is applied to portions of the panels by workers where the panels are to be marked for forming V-shaped grooves, holes for inserting fasteners and joinery portions. At station 2 the marking compositions are selectively marked by workers using a 532 nm Nd:YAG laser at 2 mW. At station 3 the panels are drilled to form holes or cut to form grooves and joinery portions. The remaining portions of the marking composition are then peeled from the panels and discarded.

The panels are then transported to construction cites or sent to warehouses for storage and later use.

### EXAMPLE 4

The following composition is prepared.

TABLE 4

| Components | Weight Percent |
|---|---|
| Copolymer of n-hexyl methacrylate, | 85 |
| methylmethacrylate, n-butyl acrylate, | |
| styrene, and methacrylic acid | |
| 9,10-Phenanthrenequinone | 0.5 |
| Triethanolamine Triacetate | 1.3 |
| Leuco Crystal Violet | 0.5 |
| Conjugated Cyclopentanone | 0.2 |
| Hexaarylbiimidazole | 2 |
| Silicone Vinyl Copolymer | 10 |
| Methyl Ethyl Ketone | Sufficient amount of methyl |
| | ethyl ketone is added to |
| | bring the formulation to |
| | 100 wt % |

The components are mixed together at 20° C. using conventional mixing apparatus to form a homogeneous mixture. The mixing is done under red light.

The homogeneous mixture is roller coated on a releasable adhesive tape with a polyethylene terephthalate backing having a thickness of 5 mm. Methyl ethyl ketone is driven off using a conventional electric fan at 20° C.

The tape is applied to wool sweat shirts and a 532 nm laser at 4 mW from a hand held laser is selectively applied to the tape to form an outline of the Northwestern University logo. The laser causes the selected portions of the coating to go from amber to clear. The tape is scored along the clear portions and the inner sections are removed. A purple dye is then applied to the sections of the tape which are removed. When the dye is dry, the remainder of the tape is removed from the sweat shirts.

### EXAMPLE 5

The following formulation is prepared.

TABLE 5

| Components | Weight Percent |
|---|---|
| Vinylacetate/acrylic copolymer emulsion | 25 |
| Calcium carbonate | 20 |
| Leuco crystal violet | 1 |
| Coumarin 314 | 0.5 |
| o-chloro-heaarylbiimidazole | 6.5 |
| Polyalkyl betaine polysiloxane copolymer | 2 |
| Propylene glycol monomethyl ether acetate | 10 |
| Water | 35 |

The components are mixed to form an oil in water emulsion as described in Examples 3 and 4. The formulation is stable under ambient light.

The composition is applied to particle boards to designate lines and images by which the boards can be cut and shaped for flooring for houses, apartments and other buildings. The marking composition is applied to the particle boards by workers and then selectively imaged with a 473 nm Nd:YAG laser at 1 mW to form lines and images on the composition. The composition is scored along the lines and images, and portions within the lines and images are peeled from the particle boards. The boards are then cut and shaped to fit specific floor dimensions and shapes. The remaining portions of the composition are then peeled from the particle boards and discarded.

### EXAMPLE 6

The following composition is prepared at room temperature under red light.

| Component | Weight Percent |
|---|---|
| Vinyl acetate/acrylic copolymer emulsion | 25 |
| 2-alkyl-2-imidazoline | 15 |
| Vinyl aromatic polymer | 5 |
| Leuco Crystal Violet | 1 |
| Tribromo methyl phenyl sulfone | 6.5 |
| 2′,4′,5′,7′-tetraiodo-3,4,5,6- | 0.5 |
| tetrachlorofluorescein disodium salt | |
| 2,2′-methylene-bis(4-methyl-6-tertbutylphenol) | 2 |
| Ethylene glycol phenyl ether | 10 |
| Water | 35 |

The vinyl acetate/acrylic copolymer is known in the art and methods of preparing it are well known. Such copolymers also are commercially available under the trade-name ROVACE™ 661. The copolymer, vinyl aromatic polymer, and the 2-alkyl-2-imidazole are mixed in water to form an aqueous emulsion.

The imaging components: Leuco crystal violet, tribromo methyl phenyl sulfone, 2′,4′,5′,7′-tetraiodo-3,4,5,6-tetrachlorofluorescein disodium salt, and 2,2′-methylene-bis(4-methyl-6-tertbutylphenol) are solubilized in ethylene glycol phenyl ether to form an organic solution.

The aqueous emulsion and the organic solution are mixed to form an oil in water emulsion imaging composition. Emulsification is done using a conventional emulsifying apparatus.

The imaging composition is applied with a syringe to points on a patient who is undergoing radiation treatment. The points where the imaging composition is applied indicate where radiation is applied to treat the patient. After the composition is applied, a technician exposes each point to light at 532 nm at 2 mW to cause the composition to change to purple. The patient is then exposed to radiation at the purple points. After the radiation treatment is done the composition is peeled off and discarded. When the patient returns at a later date for additional treatment, he is marked again at the same points or different points using the peelable composition.

What is claimed is:

1. A method comprising:
a) providing a composition comprising one or more sensitizers and one or more photoreducing agents;
b) applying the composition to a work piece;
c) exposing the composition to energy at powers of 5 mW or less to affect a color or shade change to form an image on the composition; and
d) executing one or more tasks on the work piece as directed by the image.

2. The method of claim 1, wherein the one or more tasks are chosen from alignment to another reference frame, machining, alignment for forming or shaping an article, masking and labeling.

3. The method of claim 1, wherein the work piece is chosen from biological organisms, parts of aeronautical ships, interplanetary vessels, terrestrial vehicles, subterranean vehicles, marine vessels, terrestrial structures, subterranean structures, textiles and toys.

4. The method of claim 1, wherein the work piece comprises metal, wood, ceramic, stone and polymers.

5. A method comprising:
a) providing a composition comprising one or more sensitizers and one or more photoreducing agents;
b) applying the composition to a work piece;
c) selectively exposing the composition to energy at powers of 5 mW or less to affect a color or shade change to form an image on the composition;
d) selectively removing portions of the composition as directed by the image to expose portions of the work piece; and
e) executing one or more tasks on the exposed portions of the work piece.

6. The method of claim 5, further comprising a step of removing a remainder of the composition from the work piece after executing the one or more tasks on the exposed portions of the work piece.

7. A method comprising:
a) providing a composition comprising one or more sensitizers and one or more photoreducing agents;
b) applying the composition to a work piece;
c) selectively exposing the composition to energy at powers of 5 mW or less to affect a color or shade change to form an image on the work piece;
d) machining the work piece as directed by the image to modify the work piece; and
e) joining the modified work piece to one or more component parts to form an article.

8. A method comprising:
a) providing a composition comprising one or more sensitizers and one or more photoreducing agents;
b) applying the composition to a work piece;
c) selectively exposing the composition to energy at powers of 5 mW or less to affect a color or shade change to form an image on the composition;
d) aligning the work piece to one or more parts as directed by the image; and
e) joining the work piece to the one or more parts to form an article.

9. A method comprising:
a) applying a primer composition to a work piece;
b) applying a composition comprising one or more sensitizers and one or more photoreducing agents to the primer on the work piece;
c) selectively exposing the composition to energy at powers of 5 mW or less to affect a color or shade change to form an image on the composition;
d) executing one or more tasks on the work piece as directed by the image;
e) peeling the primer and composition from the work piece; and
f) joining the work piece to one or more parts to form an article.

10. The method of claim 9, wherein the one or more tasks are chosen from machining,
alignment for forming or shaping, masking and labeling.
